(19) United States
(12) Patent Application Publication
(10) Pub. No.: US 2023/0070300 A1
(43) Pub. Date: Mar. 9, 2023

(54) EMBEDDED MEMORY LIFETIME TESTING

(71) Applicant: Micron Technology, Inc., Boise, ID (US)

(72) Inventors: Domenico Balzano, Napoli (IT); Salvatore Comitato, Caserta (IT); Lucia Santojanni, Napoli (IT); Danila D'Angelo, Napoli (IT); Domenico Punzo, Napoli (IT)

(21) Appl. No.: 17/466,457

(22) Filed: Sep. 3, 2021

(51) Int. Cl. G06F 3/06

(52) U.S. Cl. CPC G06F 3/0616; G06F 3/0619; G06F 3/0649; G06F 3/0659; G06F 3/0679

(57) ABSTRACT

Embedded memory lifetime testing is described herein. An example system includes a memory device configured to store instructions for performing a test to determine a remaining lifetime of the memory device, and a controller coupled to the memory device. The controller can be configured to, responsive to receipt of a command from a host, receive, from the memory device, the instructions for performing the test, and execute the instructions to perform the test to determine the remaining lifetime of the memory device.

### TECHNICAL FIELD

Embodiments of the disclosure relate generally to memory systems and sub-systems, and more specifically, relate to embedded memory lifetime testing.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

Vehicles are becoming more dependent upon memory sub-systems to provide storage for components that were previously mechanical, independent, or non-existent. A vehicle can include a computing system, which can be a host for a memory sub-system. The computing system can run applications that provide component functionality. The vehicle may be driver operated, driver-less (autonomous), and/or partially autonomous. The memory device can be used heavily by the computing system in a vehicle.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 is a flow diagram of an example method for operating a memory sub-system in accordance with some embodiments of the present disclosure.

FIG. 3 illustrates an example of a system including a computing system in a vehicle in accordance with some embodiments of the present disclosure.

FIG. 4 is a block diagram of an example computer system in which embodiments of the present disclosure may operate.

### DETAILED DESCRIPTION

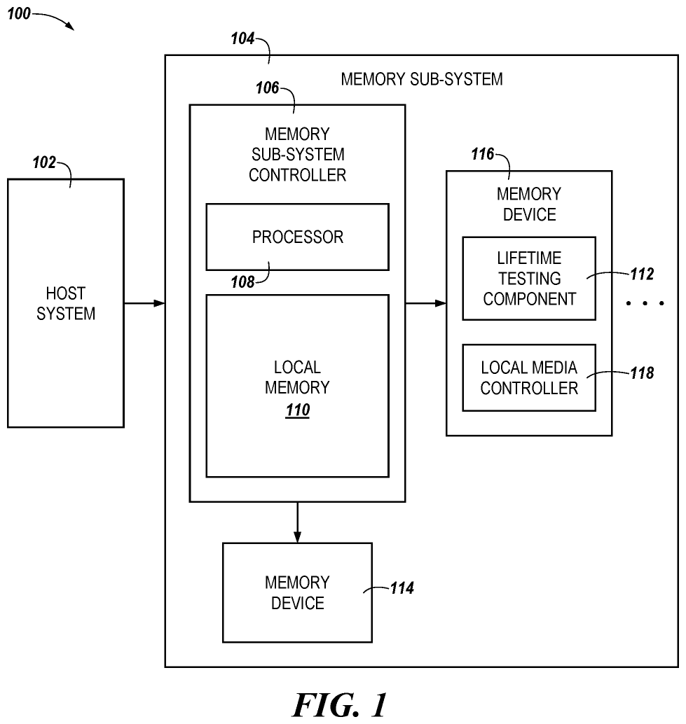

Aspects of the present disclosure are directed to embedded memory lifetime testing, and in particular to memory sub-systems that include a lifetime testing component to perform a test to determine the remaining lifetime of memory devices of the memory sub-system. A memory sub-system can be a storage system, storage device, a memory module, or a combination of such. An example of a memory sub-system is a storage system such as a solid-state drive (SSD). Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system

As an example, a vehicle can include a memory sub-system, such as a solid state drive (SSD). The memory sub-system can be used for data storage by various components of the vehicle, such as applications that are run by a host system of the vehicle. One example of such an application is an event recorder of the vehicle. The event recorder may also be referred to as a “black box” or “accident data recorder”. Embodiments of the present disclosure, however, are not limited to this example.

Tests may be performed to determine the remaining lifetime (e.g., an anticipated failure point) of a memory device, for example, during production of the memory device (e.g., while the memory device a stand-alone device). In some approaches, such tests can be performed using an external tester. However, performing such tests using an external tester may involve an extended command and response sequence (e.g., multiple commands) between a host (e.g., the external tester machine) and the memory device, which cause the test to have a high time overhead.

Tests may also be performed to determine the remaining lifetime of a memory device after production of the memory device has been completed (e.g., on the customer side, after the memory device has been mounted on the board of the memory sub-system). In some approaches, such post-production tests may involve removing (e.g., de-soldering or de-touching) the memory device from the board of the memory sub-system, and then using an external tester to perform the test. However, removing the memory device from the board can place thermal and/or mechanical stress on the memory device. Such stress can corrupt the data stored by the memory device and/or cause physical damage to the memory device (e.g., cracks and/or wire connection damage), which can negatively affect (e.g., reduce) the accuracy and/or reliability of the test. Further, using an external tester to perform the test can cause the test to have a high time overhead, as previously described.

In some approaches, such post-production tests may be performed directly on the board on which the memory device is mounted (e.g., without removing the memory device from the board). However, such tests may involve additional software tools. For instance, such tests may be executed by standard commands and specific proprietary (e.g., non-standard) commands that may use dedicated test software. However, this may necessitate modifying (e.g., customizing) the existing software of the memory sub-system, which in turn may involve additional resources, time, and/or cost to debug and/or validate the modified software. Further, the test software may need to be customized for the particular board on which the memory device is mounted. Further, the use of multiple proprietary commands can expose the memory sub-system to possible external attacks. Further, execution of the test software can cause resource conflict with the firmware of the memory sub-system (e.g., the test software may not be able to be run in parallel with the sub-system firmware).

Aspects of the present disclosure address these and other deficiencies by integrating the test software in the firmware of the memory sub-system, such that the firmware can execute (e.g., run) the test software be processing a single, specific command from a host. Such an approach can eliminate resource conflict between the firmware and test software (e.g., both can be run in parallel). Further, such an approach can reduce or eliminate exposure of the memory sub-system to external attacks, and can reduce the time overhead of the test (e.g., as compared with approaches that use extended and/or multiple command sequences to perform the test). Further, such an approach can reduce the complexity of the test software because no customization of the test software for the board of the memory sub-system is needed, and no customization of the existing software of the memory sub-system is needed. Further, such an approach can allow the test to be performed without removing the memory device from the board, which can increase the accuracy and/or reliability of the test (e.g., as compared with approaches that remove the memory device from the board to perform the test).

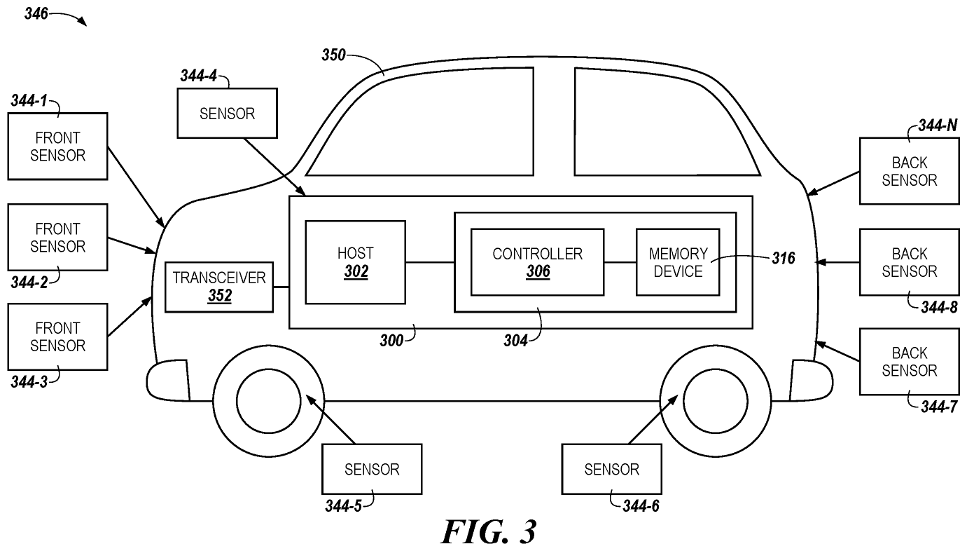

The figures herein follow a numbering convention in which the first digit or digits correspond to the drawing figure number and the remaining digits identify an element or component in the drawing. Similar elements or components between different figures may be identified by the use of similar digits. For example, 116 may reference element “16” in FIG. 1, and a similar element may be referenced as 316 in FIG. 3. Analogous elements within a Figure may be referenced with a hyphen and extra numeral or letter. Such analogous elements may be generally referenced without the hyphen and extra numeral or letter. For example, elements 344-1, 344-2, . . . , 344-N in FIG. 3 may be collectively referenced as 344. As used herein, the designator “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 illustrates an example computing system 100 that includes a memory sub-system 104 in accordance with some embodiments of the present disclosure. The memory sub-system 104 can include media, such as one or more volatile memory devices 114, one or more non-volatile memory devices 116, or a combination thereof. The volatile memory devices 114 can be, but are not limited to, random access memory (RAM), such as dynamic random access memory (DRAM), synchronous dynamic random access memory (SDRAM), and resistive DRAM (RDRAM).

A memory sub-system 104 can be a storage device, a memory module, or a hybrid of a storage device and memory module. Examples of a storage device include an SSD, a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 includes a host system 102 that is coupled to one or more memory sub-systems 104. The host system 102 can be a computing system included in a vehicle, and the computing system can run applications that provide component functionality for the vehicle, for example. In some embodiments, the host system 102 is coupled to different types of memory sub-systems 104. FIG. 1 illustrates an example of a host system 102 coupled to one memory sub-system 104. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 102 includes or is coupled to processing resources, memory resources, and network resources. As used herein, “resources” are physical or virtual components that have a finite availability within a computing system 100. For example, the processing resources include a processing device, the memory resources include memory sub-system 104 for secondary storage and main memory devices (not specifically illustrated) for primary storage, and the network resources include as a network interface (not specifically illustrated). The processing device can be one or more processor chipsets, which can execute a software stack. The processing device can include one or more cores, one or more caches, a memory controller (e.g., NVDIMM controller), and a storage protocol controller (e.g., PCIe controller, SATA controller, etc.). The host system 102 uses the memory sub-system 104, for example, to write data to the memory sub-system 104 and read data from the memory sub-system 104.

The host system 102 can run one or more applications. For instance, the applications can run on an operating system (not specifically illustrated) executed by the host system 102. An operating system is system software that manages computer hardware, software resources, and provides common services for the applications. An application is a collection of instructions that can be executed to perform a specific task. By way of example, the application can be a black box application for a vehicle, however embodiments are not so limited.

The host system 102 can be coupled to the memory sub-system 104 via a physical host interface. Examples of a physical host interface include, but are not limited to, a serial advanced technology attachment (SATA) interface, a PCIe interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open not-and (NAND) Flash Interface (ONFI), Double Data Rate (DDR), Low Power Double Data Rate (LPDDR), or any other interface. The physical host interface can be used to transmit data between the host system 102 and the memory sub-system 104. The host system 102 can further utilize an NVM Express (NVMe) interface to access the non-volatile memory devices 116 when the memory sub-system 104 is coupled with the host system 102 by the PCIe interface. The physical host interface can provide an interface for passing control, address, data, and other signals between the memory sub-system 104 and the host system 102. FIG. 1 illustrates a memory sub-system 104 as an example. In general, the host system 102 can access multiple memory sub-systems via a same communication connection, multiple separate communication connections, and/or a combination of communication connections.

The host system 102 can send requests to the memory sub-system 104, for example, to store data in the memory sub-system 104 or to read data from the memory sub-system 104. For example, the host system 102 can use the memory sub-system 104 to provide storage for a black box application. The data to be written or read, as specified by a host request, is referred to as “host data.” A host request can include logical address information. The logical address information can be a logical block address (LBA), which may include or be accompanied by a partition number. The logical address information is the location the host system associates with the host data. The logical address information can be part of metadata for the host data. The LBA may also correspond (e.g., dynamically map) to a physical address, such as a physical block address (PBA), that indicates the physical location where the host data is stored in memory.

An example of non-volatile memory devices 116 include NAND type flash memory. NAND type flash memory includes, for example, two-dimensional NAND (2D NAND) and three-dimensional NAND (3D NAND). The non-volatile memory devices 116 can be other types of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM), and three-dimensional cross-point memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

Each of the non-volatile memory devices 116 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the non-volatile memory devices 116 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the non-volatile memory devices 116 can be grouped as pages that can refer to a logical unit of the memory device used to store data. With some types of memory (e.g., NAND), pages can be grouped to form blocks.

The memory sub-system controller 106 (or controller 106 for simplicity) can communicate with the non-volatile memory devices 116 to perform operations such as reading data, writing data, erasing data, and other such operations at the non-volatile memory devices 116. The memory sub-system controller 106 can include hardware such as one or more integrated circuits and/or discrete components, or a combination thereof. The hardware can include a digital circuitry with dedicated (i.e., hard-coded) logic to perform the operations described herein. The memory sub-system controller 106 can be a microcontroller, special purpose logic circuitry (e.g., a field programmable gate array (FPGA), an application specific integrated circuit (ASIC), etc.), or other suitable circuitry.

The memory sub-system controller 106 can include a processing device 108 (e.g., a processor) configured to execute instructions stored in local memory 110. Local memory 110 can be, for instance, static random access memory (SRAM). In the illustrated example, the local memory 110 of the memory sub-system controller 106 is an embedded memory configured to store instructions for performing various processes, operations, logic flows, and routines that control operation of the memory sub-system 104, including handling communications between the memory sub-system 104 and the host system 102. For example, local memory 110 can store instructions for performing a test to determine the remaining lifetime of memory device 116, as will be further described herein.

In some embodiments, the local memory 110 can include memory registers storing memory pointers, fetched data, etc. The local memory 110 can also include ROM for storing micro-code, for example. While the example memory sub-system 104 in FIG. 1 has been illustrated as including the memory sub-system controller 106, in another embodiment of the present disclosure, a memory sub-system 104 does not include a memory sub-system controller 106, and can instead rely upon external control (e.g., provided by an external host, or by a processor or controller separate from the memory sub-system 104).

In general, the memory sub-system controller 106 can receive information or operations from the host system 102 and can convert the information or operations into instructions or appropriate information to achieve the desired access to the non-volatile memory devices 116 and/or the volatile memory devices 114. The memory sub-system controller 106 can be responsible for other operations such as wear leveling operations, error detection and/or correction operations, encryption operations, caching operations, and address translations between a logical address (e.g., logical block address) and a physical address (e.g., physical block address) associated with the non-volatile memory devices 116. The memory sub-system controller 106 can further include host interface circuitry to communicate with the host system 102 via the physical host interface. The host interface circuitry can convert a query received from the host system 102 into a command to access the non-volatile memory devices 116 and/or the volatile memory devices 114 as well as convert responses associated with the non-volatile memory devices 116 and/or the volatile memory devices 114 into information for the host system 102.

In some embodiments, the memory sub-system 104 can be a managed NAND (MNAND) device in which an external controller (e.g., controller 106) is packaged together with one or more NAND die (e.g., the non-volatile memory device 116). In an MNAND device, the external controller 106 can handle high level memory management functions such as media management and the local media controller 118 can manage some of the lower level memory processes such as when to perform programming operations.

As shown in FIG. 1, non-volatile memory device 116 can include a lifetime testing component 112 that can be configured to perform the examples described herein. For example, the lifetime testing component can be stored in non-volatile memory device 116, and uploaded to local memory 110 for execution. In some embodiments, a local media controller 118 of the non-volatile memory device 116 includes at least a portion of the lifetime testing component 112. For example, the local media controller 118 can include a processor (e.g., processing device) configured to execute instructions stored on the volatile memory devices 114 for performing the operations described herein. In some embodiments, the lifetime testing component 112 is part of the host system 102, an application, or an operating system. In at least one embodiment, the lifetime testing component 112 represents data or instructions stored in the memory sub-system 104. The functionality described with respect to the lifetime testing component 112 can be embodied in machine-readable and executable instructions stored in a tangible machine-readable medium.

For example, lifetime testing component 112 can comprise instructions (e.g., software) for performing a test to determine the remaining lifetime of memory device 116. For instance, controller 106 can receive the instructions for performing the test (e.g., the test software) from memory device 116 for execution in local memory 110. Local memory 110 can also store instructions (e.g., firmware) for performing additional operations (e.g., normal system operations) on memory device 110, such as, for instance, program, erase, and sense operations, and the test software of lifetime testing component 112 can be integrated in this system firmware. For instance, the test software can be an integrated module of the system firmware, such that it can be loaded and executed in a manner analogous to that of the system firmware.

For example, during normal system operations, lifetime testing component 112 (e.g., the test software) can be inactive. However, responsive to (e.g., upon) receipt of a command (e.g., a single command) from host 102, controller 106 (e.g., with the use of processor 108 and lifetime testing component 112) can execute the test software to perform the test to determine the remaining lifetime of memory device 116. For instance, the test software may only be executable to perform the test responsive to receipt of a specific test command from host 102 (e.g., the test software may not be uploaded from memory device 116 to controller 106 for execution without receipt of the specific test command). As such, the test can be run on demand (e.g., only when the test is desired), by processing only one specific test command from host 102 (e.g., instead of using multiple commands). For example, the single command can cause controller 106 to perform the test, which can include a sequence of access operations (e.g., multiple program and/or sense operations) that are automatically performed in accordance with the test software uploaded from memory device 116, without needing additional commands from host 102. Further, the sequence of access operations can be performed without outputting data to host 102 between the operations. Rather, only the final result of the test may be output to host 102 by controller 106 upon completion of the sequence of access operations.

Determining the remaining lifetime of memory device 116 can comprise, for instance, determining (e.g., anticipating and/or predicting) a failure point of the memory device. For example, the remaining lifetime of memory device 116 can be the total number of program and/or erase cycles that can be performed on the memory device (e.g., after the test) prior to a failure of the memory device, and/or the total amount of data programmable to the memory device (e.g., after the test) prior to a failure of the memory device. However, embodiments are not limited to these examples (e.g., other indicators can be used to determine the remaining lifetime of the memory device).

Controller 106 can provide an indication of the remaining lifetime of memory device 116 (e.g., an indication the results of the test). For instance, controller 106 can send (e.g., transmit) an indication of the remaining lifetime to host 102.

The test to determine the remaining lifetime of memory device 116 can be, for example, an error test. For instance, performing the test can include detecting errors (e.g., a quantity of errors and/or an error rate) associated with the data stored in memory device 116. As an additional example, the test can be an operation verification test. For instance, performing the test can include performing program verification and/or erase verification operations on memory device 116. As an additional example, the test can be an electrical short test. For instance, performing the test can include detecting electrical shorts (e.g., a quantity and/or rate of shorts) occurring on access (e.g., word) lines and/or sense (e.g., bit) lines of memory device 116. Embodiments of the present disclosure, however, are not limited to a particular type of test to determine the remaining lifetime of memory device 116.

While the test to determine the remaining lifetime of memory device 116 is being performed, controller 106 (e.g., with the use of processor 108 and system firmware of local memory 110) can perform additional operations (e.g., normal system operations to access memory device 116) on memory device 116, such as, for instance, program, erase, and sense operations. For example, controller 106 can receive (e.g., from host 102) instructions (e.g., commands) to access memory device 116 to perform such operations, and/or process (e.g., execute) such instructions, while performing the test. For instance, the system firmware and test software can both be executed in parallel without any memory resource conflict. For example, the test software can be executed as a feature of the system firmware when running in parallel. As such, controller 106 can continue to receive and process commands from host 102 to access memory device 116 while performing the test, and can manage (e.g., allocate) local memory 110 to store and execute the test software in parallel with the new access operations without any memory conflict.

The test to determine the remaining lifetime of memory device 116 can be performed multiple times throughout the lifetime of memory device 116 (e.g., each time the command to perform the test is received from host 102). For example, subsequent to performing the test (e.g., later in the lifetime of memory device 116), controller 106 may again receive the command to perform the test from host 102. Responsive to again receiving the test command, controller 106 can again execute the test software to perform the test to determine the remaining lifetime of memory device 116.

The memory sub-system 104 can also include additional circuitry or components that are not illustrated. In some embodiments, the memory sub-system 104 can include and address circuitry (e.g., a row decoder and a column decoder) that can receive an address from the memory sub-system controller 114 and decode the address to access the non-volatile memory devices 116.

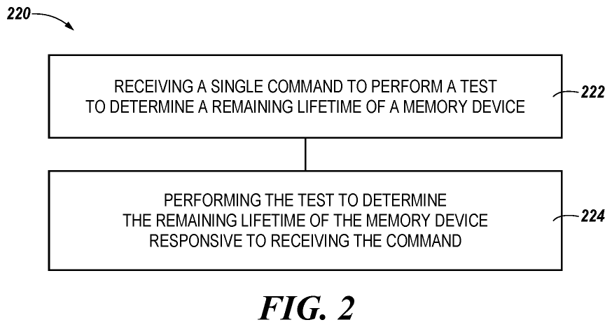

FIG. 2 is a flow diagram of an example method 220 for operating a memory sub-system accordance with some embodiments of the present disclosure. The method can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by or using the memory sub-system controller 106, processing device 108, lifetime testing component 112, non-volatile memory device 116 and/or volatile memory device 114, and/or local media controller 118 shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 222 in the example method of FIG. 2, a single command to perform a test to determine a remaining lifetime of a memory device is received. The single command can be received from a host (e.g., host 102 previously described in connection with FIG. 1), and the memory device can be, for instance, memory device 116 previously described in connection with FIG. 1. Further, the test can be any type of test that can be used to determine the remaining lifetime of the memory device, as previously described herein (e.g., in connection with FIG. 1).

At block 224 in the example method of FIG. 2, the test to determine the remaining lifetime of the memory device is performed responsive to receiving the single command. Determining the remaining lifetime of memory device 116 can comprise, for instance, determining a failure point of the memory device, as previously described herein (e.g., in connection with FIG. 1).

FIG. 3 illustrates an example of a system 346 including a computing system 300 in a vehicle in accordance with some embodiments of the present disclosure. The computing system 300 can include a memory sub-system 304, which is illustrated as including a controller 306 and non-volatile memory device 316 for simplicity but is analogous to the memory sub-system 104 illustrated in FIG. 1. The computing system 300, and thus the host 302, can be coupled to a number of sensors 344 either directly, as illustrated for the sensor 344-4 or via a transceiver 352 as illustrated for the sensors 344-1, 344-2, 344-3, 344-5, 344-6, 344-7, 344-8, . . . , 344-N. The transceiver 352 is able to receive data from the sensors 344 wirelessly, such as by radio frequency communication. In at least one embodiment, each of the sensors 344 can communicate with the computing system 300 wirelessly via the transceiver 352. In at least one embodiment, each of the sensors 344 is connected directly to the computing system 300 (e.g., via wires or optical cables).

The vehicle 350 can be a car (e.g., sedan, van, truck, etc.), a connected vehicle (e.g., a vehicle that has a computing capability to communicate with an external server), an autonomous vehicle (e.g., a vehicle with self-automation capabilities such as self-driving), a drone, a plane, a ship, and/or anything used for transporting people and/or goods. The sensors 344 are illustrated in FIG. 3 as including example attributes. For example, sensors 344-1, 344-2, and 344-3 are cameras collecting data from the front of the vehicle 350. Sensors 344-4, 344-5, and 344-6 are microphone sensors collecting data from the from the front, middle, and back of the vehicle 350. The sensors 344-7, 344-8, and 344-N are cameras collecting data from the back of the vehicle 350. As another example, the sensors 344-5, 344-6 are tire pressure sensors. As another example, the sensor 344-4 is a navigation sensor, such as a global positioning system (GPS) receiver. As another example, the sensor 344-6 is a speedometer. As another example, the sensor 344-4 represents a number of engine sensors such as a temperature sensor, a pressure sensor, a voltmeter, an ammeter, a tachometer, a fuel gauge, etc. As another example, the sensor 344-4 represents a camera. Video data can be received from any of the sensors 344 associated with the vehicle 350 comprising cameras. In at least one embodiment, the video data can be compressed by the host 302 before providing the video data to the memory sub-system 304.

The host 302 can execute instructions to provide an overall control system and/or operating system for the vehicle 350. The host 302 can be a controller designed to assist in automation endeavors of the vehicle 350. For example, the host 302 can be an advanced driver assistance system controller (ADAS). An ADAS can monitor data to prevent accidents and provide warning of potentially unsafe situations. For example, the ADAS can monitor sensors in the vehicle 350 and take control of vehicle 350 operations to avoid accident or injury (e.g., to avoid accidents in the case of an incapacitated user of a vehicle). The host 302 may need to act and make decisions quickly to avoid accidents. The memory sub-system 304 can store reference data in the non-volatile memory device 316 such that data from the sensors 344 can be compared to the reference data by the host 302 in order to make quick decisions.

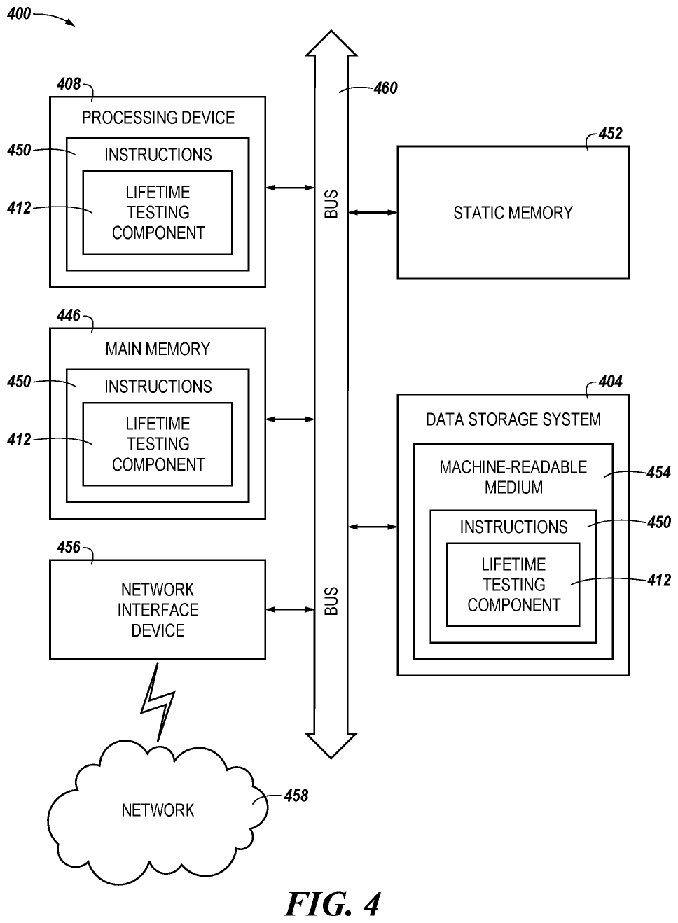

FIG. 4 is a block diagram of an example computer system in which embodiments of the present disclosure may operate. Within the computing system 400, a set of instructions, for causing a machine to perform one or more of the methodologies discussed herein, can be executed. The computing system 400 includes a processing device 408, a main memory 446, a static memory 452 (e.g., flash memory, static random access memory (SRAM), etc.), and a data storage system 404, which communicate with each other via a bus 460. The data storage system 404 is analogous to the memory sub-system 104 illustrated in FIG. 1.

The processing device 408 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 408 can also be one or more special-purpose processing devices such as an ASIC, an FPGA, a digital signal processor (DSP), network processor, or the like. The processing device 408 is configured to execute instructions 450 for performing the operations and steps discussed herein. The computing system 400 can further include a network interface device 456 to communicate over a network 458.

The data storage system 404 can include a machine-readable storage medium 454 (also known as a computer-readable medium) on which is stored one or more sets of instructions 450 or software embodying one or more of the methodologies or functions described herein. The instructions 450 can also reside, completely or at least partially, within the main memory 446 and/or within the processing device 408 during execution thereof by the computing system 400, the main memory 446 and the processing device 408 also constituting machine-readable storage media.

In one embodiment, the instructions 450 include instructions to implement functionality corresponding to the lifetime testing component 112 of FIG. 1. For instance, the instructions can include lifetime testing component 412 instructions for performing a test to determine the remaining lifetime of a memory device, that can be executed responsive to receipt of a command, as previously described herein. While the machine-readable storage medium 454 is shown in an example embodiment to be a single medium, the term “machine-readable storage medium” should be taken to include a single medium or multiple media that store the one or more sets of instructions. The term “machine-readable storage medium” shall also be taken to include a medium that is capable of storing or encoding a set of instructions for execution by the machine and that cause the machine to perform one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a machine-readable storage medium, such as, but not limited to, types of disks, semiconductor-based memory, magnetic or optical cards, or other types of media suitable for storing electronic instructions.

The present disclosure can be provided as a computer program product, or software, that can include a machine-readable medium having stored thereon instructions, which can be used to program a computer system (or other electronic devices) to perform a process according to the present disclosure. A machine-readable medium includes a mechanism for storing information in a form readable by a machine (e.g., a computer).

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising:
a memory device configured to store instructions for performing a test to determine a remaining lifetime of the memory device; and
a controller coupled to the memory device, wherein the controller is configured to, responsive to receipt of a command from a host:
receive, from the memory device, the instructions for performing the test; and
execute the instructions to perform the test to determine the remaining lifetime of the memory device.

2. The system of claim 1, wherein:
the controller includes a memory; and
the controller is configured to receive the instructions for performing the test in the memory.

3. The system of claim 2, wherein the controller is configured to store instructions for performing additional operations on the memory device in the memory.

4. The system of claim 3, wherein the instructions for performing the test are integrated in the instructions for performing the additional operations in the memory.

5. The system of claim 2, wherein the memory is a static random access memory (SRAM).

6. The system of claim 1, wherein the command comprises a single command.

7. The system of claim 1, wherein the system comprises a managed NAND device.

8. A method, comprising:
receiving, by a controller, a single command to perform a test to determine a remaining lifetime of a memory device; and
performing, by the controller, the test to determine the remaining lifetime of the memory device responsive to receiving the single command.

9. The method of claim 8, wherein determining the remaining lifetime of the memory device comprises determining a failure point of the memory device.

10. The method of claim 8, wherein the method includes performing, by the controller, additional operations on the memory device while performing the test to determine the remaining lifetime of the memory device.

11. The method of claim 8, wherein the method includes:
receiving, by the controller subsequent to performing the test to determine the remaining lifetime of the memory device, the single command to perform the test to determine the remaining lifetime of the memory device; and
performing by the controller, the test to determine the remaining lifetime of the memory device responsive to the subsequently received single command.

12. The method of claim 8, wherein the method includes operating the memory device to provide storage for an application executed for a vehicle.

13. The method of claim 8, wherein the remaining lifetime of the memory device is a total number of program and/or erase cycles that can be performed on the memory device prior to a failure of the memory device.

14. The method of claim 8, wherein the remaining lifetime of the memory device is a total amount of data programmable to the memory device prior to a failure of the memory device.

15. A system, comprising:
a memory device; and
a controller coupled to the memory device, wherein the controller is configured to:
receive a single command to perform a test to determine a failure point of the memory device; and
perform the test to determine the failure point of the memory device responsive to receiving the single command.

16. The system of claim 15, wherein the processor is configured to only perform the test to determine the failure point of the memory device responsive to receiving the single command.

17. The system of claim 15, wherein the processor is configured to provide an indication of the determined failure point of the memory device.

18. The system of claim 15, wherein the test includes detecting errors associated with data stored in the memory device.

19. The system of claim 15, wherein the test includes performing program verification operations and/or erase verification operations on the memory device.

20. The system of claim 15, wherein the test includes detecting shorts on access lines and/or sense lines of the memory device.
